(19) United States
(12) Patent Application Publication
(10) Pub. No.: US 2024/0396242 A1
(43) Pub. Date: Nov. 28, 2024

(54) TERMINAL MATERIAL WITH PLATING FILM AND COPPER SHEET FOR TERMINAL MATERIAL

(71) Applicant: MITSUBISHI MATERIALS CORPORATION, Tokyo (JP)

(72) Inventors: Kenji Kubota, Naka-shi (JP); Isao Arai, Naka-shi (JP); Naoki Miyashima, Aizuwakamatsu-shi (JP); Seiichi Ishikawa, Aizuwakamatsu-shi (JP)

(73) Assignee: MITSUBISHI MATERIALS CORPORATION, Tokyo (JP)

(21) Appl. No.: 18/688,374

(22) PCT Filed: Aug. 31, 2022
(86) PCT No.: PCT/JP2022/032751

§ 371 Date: Mar. 1, 2024

(30) Foreign Application Priority Data
Sep. 2, 2021 (JP) 2021-142948

(51) Int. Cl. H01R 13/03; C22C 9/00; C25D 3/30

(52) U.S. Cl. CPC H01R 13/03; C22C 9/00; C25D 3/30

(57) ABSTRACT

A terminal material having a plating film which can be used as a terminal for electric connection and a contact for a connector, including a base material made of copper or copper alloy and a plating film formed on the base material; the plating film has a tin layer made of tin or tin alloy; a surface-part KAM value measured by analyzing a cross section of a surface part by the EBSD method in a range of depth 1 μm in a thickness direction of the base material from an interface between the base material and the plating film is 0.15° or more and less than 90°; and a center-part KAM value in a center part of a plate thickness of the base material is 0.1 times or more and 0.6 times or less of the surface-part KAM value.

### BACKGROUND OF THE INVENTION

### Technical Field

There present invention relates to a terminal material with a plating film and a copper sheet for a terminal material having excellent adhesion of the plating film. Priority is claimed on Japanese Patent Application No. 2021-142948, filed Sep. 2, 2021, the content of which is incorporated herein by reference.

### Background Art

A terminal material with a plating film plated with tin on a plate material made of copper or a copper alloy is used as a material for an electrical connection terminal or a connecter for a contact.

For example, Patent Literature 1 describes an Sn-plated copper alloy material in which a base material is copper alloy containing 0.3% to 15% by mass of Ni, an Sn plating layer formed by reflow or molten Sn plating is provided on the surface thereof, the Sn plating layer consists, from a surface layer side, of a thickness of 0.5 μm or less of an Sn layer and a Cu—Sn alloy layer of a columnar crystal having an average cross-sectional diameter of 0.05 to 1.0 μm and an average aspect ratio of 1 or more, and a thickness of the Sn plating layer (the Sn layer and the Cu—Sn alloy layer) is 0.2 to 2.0 μm.

Patent Literature 2 describes a plated material for a connector having excellent bendability and insertion/removal property; in this material, on a base material of copper or copper alloy, an intermediate layer of alloy plating containing phosphorus at 2 to 10 percentage by mass and the balance consisting of nickel and inevitable impurities at a thickness of 0.3 to 1.0 μm and an Sn or Sn-alloy plated surface layer reflowed are formed: the intermediate layer is plated at a condition of cathode current density 2 to 20 A/dm².

Patent Literature 3 discloses a copper alloy plate in which a surface is cleaned by mechanical polishing after heat treatment and a thickness of an affected layer on a surface layer is 0.4 μm or less in order to improve adhesiveness of tin plating to a Ni—P—Sn based copper alloy plate.

### CITATION LIST

### Patent Literature

Patent Literature 1: Japanese Unexamined Patent Application, First Publication No. 2002-298963
Patent Literature 2: Japanese Unexamined Patent Application, First Publication No. 2001-181888
Patent Literature 3: Japanese Unexamined Patent Application, First Publication No. 2010-236038

### SUMMARY OF INVENTION

### Technical Problem

These tin-plated materials are also used as connector contacts of automobiles, and due to the use environment of automobiles, sever vibration and heat are applied on the connectors, which can cause problems of poor adhesion of the plating layer.

The present invention is achieved in consideration of the above circumstances, and has an object to provide a terminal material with a plating film and a copper sheet for a terminal material in which not only adhesiveness in an initial stage of producing but heat resistance can be improved by preventing peeling of the plating film even when heat load is applied while using and moreover cracks owing to a bending process can be restrained.

### Solution to Problem

A terminal material with a plating film of the present invention includes a base material made of copper or copper alloy and a plating film formed on the base material;
the plating film has a tin layer made of tin or tin alloy;
a surface-part KAM value is 0.15° or more and less than 0.90° measured by analyzing a cross section of a surface-part by the EBSD method where the surface part is in a range of 1 μm depth in a thickness direction of the base material, from a boundary surface between the base material and the plating film; and a center-part KAM value in a center part of a plate thickness of the base material is 0.1 times or more and 0.6 times or less of the surface-part KAM value.

The KAM (Kernel Average Misorientation) value is an average value of misorientation between adjacent measurement points measured by the EBSD (Electron Back Scattered Diffraction) method and indicates a local change of crystal orientation: the larger KAM value indicates that distortion is large.

In this terminal material with a plating film, the surface-part KAM value is set to be larger than the center-part KAM value: accordingly, this terminal material with the plating film is strained on the base material selectively in the vicinity of the boundary surface to the plating film, so that the strength is improved in the vicinity of the boundary surface and the adhesion of the plating film is increased. If the surface-part KAM value is less than 0.15°, the strain is small and the strength in the vicinity of the boundary surface is poor, so that the adhesion cannot be anticipated to be improved. If it is 0.90° or more, the strain becomes too large and by the influence thereof speed of mutual diffusion between copper in the base material and tin in the film to excessively increase, so that a Kirkendall void is induced and the adhesion may be deteriorated.

Furthermore, the center-part KAM value is a KAM value originated in the base material, and it is relatively low comparing with the surface-part KAM value; the strain is selectively added only on the surface part without damaging the original physical property of the base material. If the center-part KAM value is less than 0.1 times of the surface-part KAM value, the strain on the surface is excess regarding the inside of the base material, so that the internal stress concentrates in the vicinity of the surface when bending and the plating is easily peeled off. If it exceeds 0.6 times, the strain is accumulated to the inside of the base material, so that cracks are easily generated on the base material when bending.

These KAM values do not largely change even in high temperature environment, so that not only the adhesion in the initial stage of production but the heat resistance can be improved by preventing the plating film from peeling off when the heat load is applied while using, and also the cracks when bending can be restrained.

In this terminal material with a plating film, an average crystal grain size is preferably 0.5 μm or more and 3.0 μm or less in the surface part.

If the average crystal grain size is large in the surface part, tin in the plating film is restrained from diffusing into copper in the base material, so that the mutual diffusion between copper and tin is balanced and the Kirkendall void can be restrained; as a result, it is effective to prevent the plating film from peeling off.

If the average crystal grain size is minute as less than 0.5 μm, the effect of prevent the diffusion of tin is poor; if it excesses 3.0 μm, on the contrary, much copper is diffused and the void may be generated.

It is preferable that an average crystal grain size be larger than the average crystal grain size in the surface part, and 1.5 μm or more and 10 μm or less.

In the terminal material with a plating film of the present invention, the base material is preferably copper alloy containing Mg at 0.2% by mass or more and 2.0% by mass or less.

Generally, copper alloy containing Mg is appropriate for terminal material since the strength is high; however, the adhesion of the plating film is poor just as it is. The terminal material of the present invention can improve the adhesion of the plating film.

A copper sheet for a terminal material of the present invention is a plate material composed of copper or copper alloy, in which a surface-part KAM value measured by analyzing by the EBSD method a cross section of a surface part, where the surface part is in a range of 1 μm depth from a surface in a thickness direction of a sheet material, is 0.15° or more and less than 0.90°, and a center-part KAM value in a plate thickness center part of the plate material is 0.1 times or more and 0.6 times or less of the surface-part KAM value.

By plating the copper sheet for a terminal material, the adhesion to the plating film is good and it can be prevented from peeling off.

The copper sheet for a terminal material can be a copper alloy plate containing Mg at 0.2% by mass or more and 2.0% by mass or less.

Generally, copper alloy containing Mg is appropriate for terminal material since the strength is high; however, the adhesion of the plating film is poor just as it is. The adhesion of the plating film can be improved by applying this invention.

### Advantageous Effects of Invention

According to the present invention, since the surface-part KAM value, and a ratio of the KAM values between the surface part and the center part are in prescribed ranges, it is possible to improve the adhesion of the plating film; and moreover, not only the adhesion in the initial stage of production but the heat resistance can be improved by preventing the plating film from peeling off when the heat load is applied while using.

### BRIEF DESCRIPTION OF DRAWINGS

FIG. 1 It is a cross sectional view schematically showing a first embodiment of a plating film terminal material of the present invention.

FIG. 2 It is a cross sectional view schematically showing a second embodiment of a plating film terminal material of the present invention.

### DESCRIPTION OF EMBODIMENTS

Embodiments of the present invention will be described.

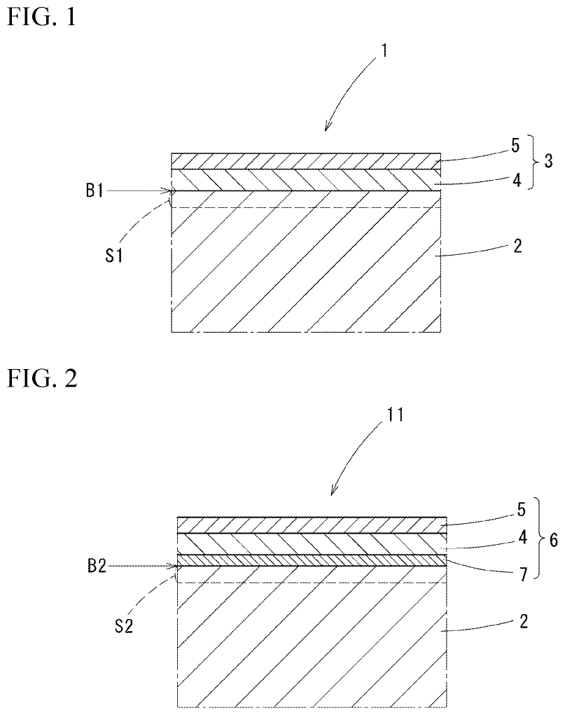

As shown in FIG. 1, a terminal material 1 with a plating film of a first embodiment has a plating film 3 formed on a surface of a base material 2; and a KAM value (a surface-part KAM value) of a surface part S1 of the base material 2 and a ratio of the surface-part KAM value and a center-part KAM value at a center part in a plate thickness are set to a specific range.

### —Base Material—

The base material 2 is a sheet material (a copper sheet for terminal material) made of copper or copper alloy and preferably contain Mg at 0.2% by mass or more and 2.0% by mass or less. For example, consisting of 0.3% by mass or more and 1.2% by mass or less of Mg, 0.001% by mass or more and 0.2% by mass or less of P, and the balance Cu and inevitable impurities, Mg containing copper alloy has high mechanical strength, so it can be used appropriately. Copper alloy containing Mg can be also used that contains more than 1.2% by mass and 2.0% by mass or less of Mg and the balance Cu and inevitable impurities. Such copper alloy containing Mg as described above is exemplified by copper alloy containing Mg, the “MSP” series (MSP1, MSP5, and MSP8), produced by Mitsubishi Materials Corporation.

The base material 2 has 0.15° or more and less than 0.90° of a surface-part KAM value measured by analyzing by the EBSD method a cross section of the surface part where in a range of depth 1 μ from the surface, and a KAM value (a center-part KAM value) at a center part of a plate thickness of the base material 2 that is 0.1 times or more and 0.6 times or less of the surface-part KAM value.

Preferably, the base material has 0.5 μm or more and 3.0 μm or less of an average crystal grain size in the surface part (the area 1 μm depth from the surface), and an average crystal grain size in the center part is more than the average crystal grain size in the surface part and is 1.5 μm or more and 10 μm or less.

The crystal grain sizes are measured by the EBSD method as in the measurement of the KAM value.

The KAM value and the crystal grain size are measured by the EBSD method as follows.

A vertical cross section including the plating film 3 (the surface viewed in the TD direction) along the rolling direction (the RD direction) of the base material 2 was mechanically polished using water-resistant abrasive paper and diamond grains, and then the measurement surface was processed using an Ar ion cross-sectional processing device (the ion milling device IM4000 manufactured by Hitachi High-Tech Corporation). For crystal orientation measurement using electron backscatter diffraction to calculate Kernel Average Misorientation (KAM) and the crystal grain size, an EBSD measurement device (the scanning electron microscope SU5000 manufactured by Hitachi High-Tech Corporation, the OIM Date Collection manufactured by EDAX/TSL) and an analysis software (OIM Data Analysis ver. 7.3 produced by EDAX/TSL) were used. The acceleration voltage of the electron beam of the EBSD measurement device was 15 kV, the measurement field of view was 3 μm×5 μm (plating thickness direction×horizontal direction of plating surface), and the measurement point interval (Step Size) for crystal orientation measurement was 0.01 μm. The data obtained by the EBSD measurement device was treated using the analysis software, so that parts where the difference of the crystal orientation between the adjacent measurement points was 5° or more were supposed to be crystal boundaries, and the KAM value and the crystal grain size are measured.

The average values of the crystal grain size and the KAM value were respectively calculated, in the range of 1 μm depth in the thickness direction of the base material from the boundary surface between the base material 2 and the plating film 3, and in the center part of the plate thickness of the base material.

### —Plating Film—

The plating film 3 formed on the base material 2 has a copper-tin alloy layer 4 made of alloy of copper and tin and a tin layer 5 made of tin or tin alloy on the copper-tin alloy layer 4 in the present embodiment. In addition, although FIG. 1 and others show only one surface of the base material 2 with enlarging, there are cases in which the plating film 3 is formed only on one surface of the base material 2 and formed on both surfaces of the base material 2.

The thickness of the layers 4 and 5 of the plating film 3 are not limited particularly though, for example, the copper-tin alloy layer 4 is formed to have the thickness 0.1 μm to 1.5 μm and the tin layer 5 is formed to have the thickness 0.1 μm to 3.0 μm.

The surface-part KAM value is a value in the range from the boundary between the base material 2 and the copper-tin alloy layer 4 to 1 μm depth of the base material in the thickness direction and is an average value of the KAM values measured at portions of thickness 1 μm. The range shown in FIG. 1 by the sign S1 is the surface part and the position shown by B1 is an interface between the surface part S1 and the plating film 3.

There is a case in which a nickel layer is formed consisting nickel or nickel alloy between the base material 2 and the copper-tin alloy layer 4 as needed. FIG. 1 shows an embodiment without a nickel layer but FIG. 2 shows a second embodiment with a nickel layer.

In a terminal material 11 with a plating film shown in FIG. 2, a plating film 6 formed on the surface of the base material 2 is formed with a nickel layer 7 made of nickel or nickel alloy, a copper-tin alloy layer 4 made of alloy of copper and tin, and a tin layer made of tin or tin alloy in this order. The nickel layer prevent copper from dispersing from the base material, and the heat resistance can be improved.

In the terminal material 11 with the plating film having the nickel layer 7, a KAM value in a range S2 of a depth of 1 μm in the thickness direction of the base material 2 from an interface B2 between the base material 2 and the nickel layer 7 is the surface-part KAM value; and a crystal grain size in the range S2 is the crystal grain size of the surface part.

The surface-part KAM value, the crystal grain size of the surface part, the center-part KAM value, and the crystal grain of the center part are the same as in the case of the terminal material 1 with the plating film having no nickel layer.

### —Manufacturing Method—

A method of manufacturing the terminal material 1 with the plating film configured as described above will be described. Hereinafter, the method of manufacturing the terminal material 1 with the plating film shown in FIG. 1 will be mainly described; and the method of manufacturing the terminal material 11 with the plating film shown in FIG. 2 will be described as needed.

### —Step of Manufacturing Base Material—

A copper ingot made of copper or copper alloy is subjected to hot rolling, cold rolling, annealing, finish cold rolling and the like to produce a copper mother plate, and the copper base plate is subjected to surface processing to form the base material (a copper sheet for terminal material of the present invention).

The surface processing is a process that mechanically processes the surface of the copper mother plate to selectively strain the surface part S1. Specifically, wet blasting is preferred.

The wet blasting is a method to process the surface by spraying mixture solution (slurry) of water and polishing agent on the surface of the copper mother plate. Since the polishing agent is mixed in the water, the polishing agent is also thrown with the grains grinded off from the surface of the copper mother plate with the water and does not remain on the surface of the copper mother plate. It is preferable to use spherical abrasive grains for the polishing agent.

Dry blasting is not appropriate since polishing agent may bite the surface of the copper mother plate and remain there.

Mechanical polishing such as buffing and the like can also be applied. However, in a case of mechanical polishing such as buffing, the crystal grain size and the KAM value do not reach desired value since the structure of the surface of the copper mother plate tends to be fine. In a case in which strain is applied on the surface by buffing, after processing to remove the fine structure by etching or the like is necessitated. The wet blasting does not need after processing.

After applying the strain to the surface part S1 of the copper mother plate by the wet blasting, chemical polishing is carried out if necessary.

The chemical polishing, for example, uses solution (chemical polishing solution) having a sulfuric acid concentration of 50 g/L, a hydrogen peroxide concentration of 5 g/L, and a chloride ion concentration 30 mg/L to dip the copper mother plate therein at bath temperature 30° C. for one minute. By performing this chemical polishing process, in a case in which the strain is excessively applied, the excessive strain part is removed. It is possible to judge whether the strain is applied excessively or not from measurement results of the KAM value by the following EBSD method.

The excessive strain part positions on the surface of the copper mother plate and can be removed by chemical polishing the copper mother plate at an appropriate thickness. The chemical polishing process can be carried out by a method such as spray jetting the chemical polishing solution to the copper mother plate other than the process of dipping the copper mother plate in the chemical polishing solution.

As described above, in the base material 2 (the copper sheet for the terminal material) which is subjected to the surface processing on the copper mother plate, the surface-part KAM value measured by the EBSD method at the surface part S1 that is in the range of the depth 1 μm from the surface is 0.15° or more and less than 0.90°; and the center-part KAM value in the center part of the plate thickness of the base material 2 is 0.1 times or more and 0.6 times or less of the surface-part KAM value. The center-part KAM value is substantially equal to the KAM value in the thickness center part of the copper mother plate. The thickness center part is a region from a position of 40% to a position of 60% of a whole thickness from the surface in the thickness direction.

In addition, measured values of the surface-part KAM value and the center-part KAM value of the base material 2 do not change between before and after forming the plating film 3 on the base material 2.

Mostly, the average crystal grain size of the surface part S1 of the baes material 2 is 0.5 μm or more and 3.0 μm or less, and the average crystal grain size of the center part is larger than the average crystal grain size of the surface part S1, 1.5 μm or more and 10 μm or less.

### —Plating Treatment Process—

Next, plating treatment is performed to form the plating film 3 on the surface of the base material 2.

For plating, after soil and a natural oxide film is removed by process of degreasing, pickling and the like on the surface of the base material 2, copper plating and tin plating on it are performed in order, and then a reflow treatment is performed. The plating layer is formed on both surfaces of the base material 2.

For the copper plating, a standard copper plating bath can be used: for example, a copper sulfate bath including copper sulfate (CuSO₄) and sulfuric acid (H₂SO₄) as main ingredients or the like can be used. The temperature of the plating bath is 20 to 50° C. and the current density is 1 to 30 A/dm².

For the plating bath for forming the tin plating layer, a standard tin plating bath can be used: for example, a sulfate bath including sulfuric acid (H₂SO₄) and stannous sulfate (SnSO₄) as main ingredients can be used. The temperature of the plating bath is 15 to 35° C. and the current density is 1 to 30 A/dm².

In the reflow treatment, the treated material after plating is heated in a heating furnace in a reducing atmosphere, for example, 240° C. to 300° C. for three seconds to 15 seconds, and then cooled.

By this reflow treatment, before the tin plating layer is melted, copper in the copper plating layer preferentially diffuses into the grain boundaries of tin, and intermetallic compound is generated to form the copper-tin alloy layer 4. The tin plating layer partially remains and the tin layer 5 is formed on the copper-tin alloy layer 4, and the plating film 3 made of copper-tin alloy layer 4 and the tin layer 5 is formed on the surface of the base material 2. There is a case in which a copper layer is formed between the copper-tin alloy layer and the base material because of remaining of a part of the copper plating layer. In this case, the crystal structure of the copper layer is grown transferring the surface state of the base material; accordingly, when the surface-part KAM value is measured after forming the plating film 3, the KAM value measured at the surface part that is in a range of depth 1 μm in the thickness direction from the boundary between the copper-tin alloy layer and the copper layer may be the surface-part KAM value.

The nickel layer 7 is formed as needed on the surface of the base material 2; when the nickel layer 7 is provided, nickel plating is performed before copper plating. For the nickel plating to form the nickel-plating layer, a standard nickel-plating bath may be used; for example, a sulfate bath including sulfuric acid (H₂SO₄) and nickel sulfate (NiSO₄) as main ingredients may be used. The temperature of the plating bath is 20° C. or more and 60° C. or less, the current density is 5 to 60 A/dm². The film thickness of the nickel-plating layer is 0.05 μm or more and 1.0 μm or less, for example.

The terminal material 1 with the plating film has the larger surface-part KAM value than the center-part KAM value; accordingly, the terminal material 1 with the plating film is in a state in which the strain is applied selectively in the vicinity of the interface B1 between the base material 2 and the plating film 3, the strength in the vicinity of the interface is improved and the strength of the bonded part is improved; as a result, the adhesiveness of the plating film 3 is increased. If the surface-part KAM value is less than 0.15°, the strain is small and the strength in the vicinity of the interface is poor and the improvement of the adhesiveness is not expected. If it is 0.90° or more, speed of the mutual diffusion between the copper in the base material 2 and the tin in the plating film 3 is too large, so that Kirkendall void is induced and the adhesiveness is deteriorated.

The center-part KAM value is the original value of the base material 2, and is relatively lower to the surface-part KAM value; not spoiling the original property of the base material 2, the strain is selectively applied to the surface part S1. If the center-part KAM value is less than 0.1 times of the surface-part KAM value, the strain applied on the surface is excessively large regarding the inside of the base material; and the internal stress is concentrated to the vicinity of the surface when the bending process is performed, and the plating tends to be peeled off. If it excesses 0.6 times, the strain is accumulated to the inside of the base material, and cracks tends to be generated in the base material when the bending process is performed.

In this case, the KAM value is not largely changed even in high temperature environment, not only the adhesiveness in the primary stage of production, the plating film is prevented from peeling off even when heat load is applied when it is used and the heat resistance is improved, and it can be restrained to generate the cracks when the bending process.

A preferable value of the surface-part KAM value is 0.30° or 0.60° or less, and a ratio of the center-part KAM value to the surface part KAM value is preferably 0.2 times or more and 0.4 times or less.

It is possible to increase not only the surface part S1 of the base material 2 but the overall KAM value by, for example, increasing the rolling reduction rate during rolling; however, it is not preferable since the original material characteristic of the base material 2 is also changed in this case.

If the average crystal grain size of the surface part S1 is large, tin in the plating film 3 is restrained from diffusing into copper in the base material 2, so that the mutual diffusion between copper and tin is balanced and the generation of Kirkendall void can be restrained; as a result, it is effective to prevent the plating film 3 from peeling off.

If the average crystal size is fine as less than 0.5 μm, the effect of restraining the diffusion of tin is poor; if it exceeds 3.0 μm, more copper diffuses conversely and it may cause voids. Accordingly, the average crystal size of the surface part S1 is preferably 0.5 μm or more and 3.0 μm or less; more preferably, 0.6 μm or more and 1.5 μm or less.

In the embodiment, the “MSP” series (MSP1, MSP5, MSP8) made by Mitsubishi Materials Corporation were exemplified as the Mg-containing copper alloy of the base material 2; and moreover, copper alloy made by Mitsubishi Materials Corporation other than the Mg-containing copper alloy may be used such as Cu—Ni—Si-based alloy (MAX2251), Cu—Fe—P-based alloy (TAMAC194), Cu—Zr-based alloy (C151), Cu—Cr—Zr-based alloy (MZC1), and Cu—Zn—Ni—Sn-based alloy (MNEX10).

### Examples

Control of the KAM value and the average grain size of the surface part is accomplished by sequentially performing the appropriate strain-imparting treatment by a physical treatment and a chemical polishing treatment for removing the excessive strained part.

Plate materials of copper alloy having a structure shown in Table 1 were prepared as the base material, were subjected to the strain-imparting treatment by performing the wet blasting on the surface; alkaline electrolytic degreasing was performed for removing the polishing grains used in the blasting, and then the chemical polishing treatment selectively removing the excessive-strained part was performed. As comparative examples, those that were not wet-blasted, and were only wet blasted but not chemically polished were also made. Then, the plate materials were pickled and subjected to copper plating. Some samples were subjected to copper plating after nickel plating. After the copper plating, tin plating was performed and reflow treatment was performed, so that the samples shown in Table 1 were made.

In this case, the thickness of the tin plating layer was 1 μm, the thickness of the copper plating layer was 0.5 μm, and the thickness of the nickel-plating layer was 0.5 μm. The wet blasting was carried out for Examples 1 to 9 by spraying a slurry containing concentration 5 vol % of spherical zirconia having a particle size 40 μm with a condition of air pressure 0.4 MPa and a projection angle 45°.

As the chemical polishing treatment, using a solution having sulfuric acid concentration 50 g/L, hydrogen peroxide concentration 5 g/L, and chloride ion concentration 30 mg/L, and performing dipping treatment at the bath temperature 30° C. for one minute, the excessive-strained part was removed.

The KAM value and the crystal grain size of the center part of the base material are dependent on the original KAM value and the crystal grain size in the prepared base material; accordingly, the base materials having different KAM values and crystal grain sizes were prepared. The KAM value and the crystal grain size of the surface part are determined by the prepared base material, the strain-imparting treatment and the chemical polishing treatment; thus, the time of the wet blasting and the chemical polishing treatment were adjusted to obtain the desired KAM value and the crystal grain size.

TABLE 1

| | | Alloy Composition of Base | Wet | Chemical | Nickel |
|---|---|---|---|---|---|
| Sample No. | | Material (mass %) Balance Cu | Blasting | Polishing | Plating |
| Example | 1 | Fe: 2.3, Zn: 0.12, P: 0.03 | Executed | Executed | Not Executed |
| | 2 | Zn: 10, Ni: 0.6, Sn: 0.6, | Executed | Executed | Not Executed |
| | | Fe: 0.01, P: 0.04 | | | |
| | 3 | Zn: 30 | Executed | Executed | Not Executed |
| | 4 | Zr: 0.1 | Executed | Executed | Not Executed |
| | 5 | Ni: 2.0, Zn: 1.0, Sn: 0.5, | Executed | Executed | Executed |
| | | Si: 0.5 | | | |
| | 6 | Mg: 0.7, P: 0.005 | Executed | Executed | Not Executed |
| | 7 | Mg: 0.2 | Executed | Executed | Not Executed |
| | 8 | Mg: 0.7, P: 0.005 | Executed | Executed | Not Executed |
| | 9 | Mg: 2.0 | Executed | Executed | Not Executed |
| Comparative | 1 | Fe: 2.3, Zn: 0.12, P: 0.03 | Not Executed | Not Executed | Not Executed |
| Example | 2 | Fe: 2.3, Zn: 0.12, P: 0.03 | Executed | Not Executed | Not Executed |
| | 3 | Fe: 2.3, Zn: 0.12, P: 0.03 | Not Executed | Not Executed | Not Executed |
| | 4 | Fe: 2.3, Zn: 0.12, P: 0.03 | Not Executed | Not Executed | Not Executed |
| | 5 | Fe: 2.3, Zn: 0.12, P: 0.03 | Not Executed | Not Executed | Not Executed |
| | 6 | Fe: 2.3, Zn: 0.12, P: 0.03 | Not Executed | Not Executed | Not Executed |
| | 7 | Fe: 2.3, Zn: 0.12, P: 0.03 | Not Executed | Not Executed | Not Executed |
| | 8 | Fe: 2.3, Zn: 0.12, P: 0.03 | Not Executed | Not Executed | Not Executed |

For these samples, the KAM value and the crystal grain size of the surface part and the center part were measured by the method described above, and the adhesion test was performed.

### —Measurement of KAM Value and Crystal Grain Size—

The cross section including the plating layers (the surface viewed in the TD direction) along the rolling direction (the RD direction) of each sample was mechanically polished using water-resistant abrasive paper and diamond abrasive grains, and then the measurement surface was processed using an Ar ion cross-sectional processing device (ion milling device IM4000 manufactured by Hitachi High-Tech Corporation). For measurement of crystal orientation using electron backscatter diffraction for calculating Kernel Average Misorientation (KAM) and the crystal grain size, an EBSD measurement device (a scanning electron microscope SU5000 manufactured by Hitachi High-Tech Corporation and OIM Data Collection manufactured by EDAX/TSL) and analysis software (EDAX/TSL OIM Data Analysis ver. 7.3) were used. The acceleration voltage of the electron beam of the EBSD measurement device was 15 kV, the measurement field of view was 3 μm×5 μm (plating thickness direction×plating surface horizontal direction), and the measurement point interval of the crystal orientation measurement (Step Size) was 0.01 μm. Data obtained by the EBSD measurement device was processed using the analysis software, and the KAM value and the crystal grain size were measured, supposing a portion where the difference of the crystal orientation between the adjacent measurement point was 5° or more to be the crystal grain boundary.

The crystal grain size was calculated by the average value of the major axis (the length of the longest straight line drawn in the grain under the condition that it does not come into contact in the middle with the grain boundary) and the minor axis (the length of the longest straight line drawn in the grain in the direction intersecting the major axis at right angle under the condition that it does not come into contact in the middle with the grain boundary).

The KAM value was calculated by calculating the average value of the misorientation between a specific measurement point in a crystal grain and the adjacent measurement points in the same crystal grain and from the average value of the whole crystal grains disposed in the measurement field of view.

The average values of the KAM value and the crystal grain size were calculated respectively in the range of depth 1 μm in the thickness direction of the base material from the interface of the plating film and the center part of the thickness direction of the base material.

### —Adhesion Test—

The samples were heated at a temperature 150° C. for 240 hours in the air atmosphere, then adhesion of the plating film was evaluated by the tape test method of JIS H 8504. In order to make the test strict, cuts were made by a sharp cutter before the tape was stuck to form a square with sides 2 mm on the plating film surface, and then the tape was stuck. Peeling off the tape, those that the plating film was peeled off from the material along with the tape (50% or more of the whole were peeled off) were “D”, and those that the plating film was peeled off from the material at some amount (less than 50% and 5% or more of the whole) were “C”. Those that the plating film was peeled off from the material but it was a small peeling (less than 5% of the whole) were “B”, those that the plating film did not adhere on the tape and was not peeled off were “A”. There is no practical problem if the evaluation is “C” or better.

### —Bending Workability Test—

As the bending workability test, the sample was cut off in the bad way into a width 10 mm×a length 60 mm in a direction orthogonal to the rolling direction, a 180° bending test was performed according to the metal material bending test method defined in JIS Z 2248 with a ratio R/t=1 of the bending radius R and the thickness “t” of the pressing part, and it was observed whether cracks and the like were appeared on the surface and the cross section of the bended part by an optical microscope with a magnification of 50×. Those that the cracks and the like did not appear and the surface state was not largely changed before and after bending were “A”, the state change such as gloss reduction and the like was observed on the surface but the generation of the cracks was not recognized were “B”, the cracks were observed but the peeling of the plating was not recognized were “C”, and the peeling of the plating itself was observed were “D”.

Note that the adhesion after heating the samples were evaluated but the test was not carried out before heating since the adhesion is supposed to be excellent before heating, i.e., immediately after the production if the evaluation of the adhesion after heating was good.

TABLE 2

| | | | Magnification | | | | |
|---|---|---|---|---|---|---|---|
| | | | of Center-part | | | | |
| | | | KAM Value to | Surface Part | Center Part | | |
| | | Surface-part | Surface-part | Average Grain | Average Grain | | Bending |
| | | KAM Value | KAM value | Size | Size | Adhesion | Workability |
| Sample No. | | (°) | (times) | (μm) | (μm) | Test | Test |
| Example | 1 | 0.15 | 0.3 | 0.2 | 0.5 | C | A |
| | 2 | 0.89 | 0.2 | 3.2 | 15.0 | C | A |
| | 3 | 0.60 | 0.1 | 0.2 | 12.0 | C | B |
| | 4 | 0.40 | 0.6 | 0.2 | 1.0 | C | B |
| | 5 | 0.30 | 0.6 | 0.5 | 1.5 | A | B |
| | 6 | 0.60 | 0.4 | 3.0 | 8.0 | B | A |
| | 7 | 0.20 | 0.3 | 1.2 | 3.0 | B | A |
| | 8 | 0.40 | 0.5 | 1.5 | 5.0 | B | A |
| | 9 | 0.80 | 0.2 | 0.6 | 2.0 | B | A |
| Comparative | 1 | 0.10 | 0.7 | 4.0 | 12.0 | D | C |
| Example | 2 | 1.00 | 0.05 | 0.1 | 20.0 | D | D |
| | 3 | 1.50 | 10.0 | 0.1 | 0.3 | D | C |
| | 4 | 0.15 | 1.0 | 5.0 | 5.0 | C | C |
| | 5 | 0.60 | 0.7 | 0.1 | 0.5 | C | C |
| | 6 | 0.90 | 0.07 | 0.1 | 16.0 | D | D |
| | 7 | 0.12 | 0.6 | 4.0 | 8.0 | D | B |
| | 8 | 1.00 | 0.1 | 0.3 | 25.0 | D | B |

As shown in Table 2, the samples of the Examples in which the surface-part KAM value was 0.15° or more and less than 0.90° and the center-part KAM value was 0.1 times or more and 0.6 times or less of the surface-part KAM value were all evaluated “C” or better in the adhesion test, so it was recognized that the adhesion of the plating film after heating was good. The bending workability was also good as “C” or better Above all, Examples 5 to 9 in which the surface part average grain size was 0.5 μm or more and 3.0 μm or less were evaluated “B” or better in the adhesion test, and were excellent. The average crystal grain size of the center part of these Examples 5 to 9 are in the range of 1.5 μm or more and 10 μm or less. Moreover, Example 5 having the nickel layer was evaluated “A” in the adhesion test, and was especially good.

Note that, as described above, the adhesion before heating the samples, i.e., immediately after manufacturing results in more excellent than the result of the adhesion test of Table 2.

On the other hand, in Comparative Example 1, the surface-part KAM value was small as 0.10° and the magnification of the center-part KAM value to the surface-part KAM value was large as 0.7 times; in contrast, in Comparative Example 2, the surface KAM value was large as 1.00° and the magnification of the KAM value was small as 0.05; and in Comparative Example 3, the surface-part KAM value was large as 1.50° and the magnification of the KAM value was large as 10.0 times; in both cases, the peeling of the plating film was recognized in the adhesion test. Comparative Example 1 was poor, since the magnification of the center-part KAM value to the surface-part KAM value was large and the cracks also occurred during the bending process.

In Comparative Example 4 to Comparative Example 5, although the surface-part KAM value was in the range of 0.15° or more and less than 0.90°, the magnification of the center-part KAM value to the surface-part KAM value was large in both Comparative Example 4 and Comparative Example 5, the cracks occurred during the bending process and they were poor. In Comparative Examples 2 and 6, since the magnification was small as 0.05 times and 0.07 times, the peeling of the plating occurred by the influence during the bending process. On the contrary, in Comparative Example 7 and Comparative Example 8, although the magnification of the center-part KAM value to the surface-part KAM value were 0.1 times or more and 0.6 times or less, since the surface-part KAM value of Comparative Example 7 was small as 0.12 and the surface-part KAM value of Comparative Example 8 was large as 1.00, the peeling of the plating film was recognized in the adhesion test, respectively.

### INDUSTRIAL APPLICABILITY

It is possible to provide a terminal material with a plating film and a copper sheet for a terminal material as material having a plating film of a terminal for electric connection and a contact for a connector, in which not only adhesion in the initial stage of manufacture but also when the heat load is applied during usage, the peeling of the plating film is prevented to improve the heat resistance, and the generation of the cracks can be restrained during the bending process.

### REFERENCE SIGNS LIST

1, 11 Terminal material with plating film
2 Base material
3,6 Plating film
4 Copper-tin alloy layer
5 Tin layer
7 Nickel layer
S1, S2 Surface part
B1, B2 Interface

The invention claimed is:

1. A terminal material with a plating film comprising a base material made of copper or copper alloy and a plating film formed on the base material, wherein
the plating film has a tin layer made of tin or tin alloy, and
a surface-part KAM value is 0.15° or more and less than 0.90° measured by analyzing a cross section of a surface-part by the EBSD method; where the surface part is in a range of 1 μm depth in a thickness direction of the base material, from a boundary surface between the base material and the plating film; and a center-part KAM value in a center part of a plate thickness of the base material is 0.1 times or more and 0.6 times or less of the surface-part KAM value.

2. The terminal material having a plated film according to claim 1, wherein an average crystal grain size is 0.5 μm or more and 3.0 μm or less in the surface part.

3. The terminal material having a plated film according to claim 2, wherein an average crystal grain size is larger than the average crystal grain size in the surface part, and 1.5 μm or more and 10 μm or less.

4. The terminal material with a plating film according to claim 1, wherein the base material is copper alloy containing Mg at 0.2% by mass or more and 2.0% by mass or less.

5. A copper sheet for a terminal material that is a plate material composed of copper or copper alloy, wherein
a surface-part KAM value measured by analyzing by the EBSD method a cross section of a surface part, where the surface part is in a range of 1 μm depth from a surface in a thickness direction of a sheet material, is 0.15° or more and less than 0.90°, and
a center-part KAM value in a plate thickness center part of the plate material is 0.1 times or more and 0.6 times or less of the surface-part KAM value.

6. The copper sheet for a terminal material according to claim 5 that is a copper alloy plate containing Mg at 0.2% by mass or more and 2.0% by mass or less.

7. The terminal material with a plating film according to claim 2, wherein the base material is copper alloy containing Mg at 0.2% by mass or more and 2.0% by mass or less.

8. The terminal material with a plating film according to claim 3, wherein the base material is copper alloy containing Mg at 0.2% by mass or more and 2.0% by mass or less.
